(19) United States
(12) Patent Application Publication
(10) Pub. No.: US 2005/0007486 A1
(43) Pub. Date: Jan. 13, 2005

(54) Image capturing apparatus

(75) Inventors: Shinichi Fujii, Osaka-shi (JP); Takeru Butsusaki, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA CAMERA, INC.

(21) Appl. No.: 10/706,358

(22) Filed: Nov. 12, 2003

(30) Foreign Application Priority Data
Jul. 8, 2003 (JP) P2003-193755

(51) Int. Cl. H04N 5/232

(52) U.S. Cl. 348/345

(57) ABSTRACT

The present invention provides a digital camera having an automatic tracking AF function, with shortened time required to re-achieve focusing after focusing becomes unmaintainable, which does not make the user feel strange. In a pattern drive AF control (normal control state), the digital camera performs pattern driving of finding an infocus lens position at the present time point around the latest infocus lens position while performing automatic tracking control of changing the position of the focus area so as to trace the movement of a main subject. When the digital camera loses the track of the subject during execution of the pattern drive AF control (normal control state), until at least predetermined time elapses (subject loss time point), pattern drive AF control (extended control state) is continued.

This application is based on application No. 2003-193755 filed in Japan, the contents of which are hereby incorporated by reference.

### BACKGROUND OF THE INVENTION

1. Field of the Invention

The present invention relates to an image capturing apparatus having an auto-focus function.

2. Description of the Background Art

With development of electronic techniques of recent years, a digital camera for generating image data is being used in a wider range. Such a digital camera is often provided with an auto-focus (AF) function for automatically realizing a focus state as one of functions of supporting photographing of the user. There are various AF modes. An AF function provided for a digital camera is mainly performed in a so-called video AF mode capable of easily achieving a high-precision auto-focus at low cost, specifically, a mode of detecting a focal point by using an image signal from an image capturing device for photographing.

Various controls of the AF provided for a digital camera are also being studied. The most basic control is called as one-shot AF. The one-shot AF is an AF control such that when an AF start instruction is given (typically, a shutter start button (referred to as a shutter button hereinafter) is partway pressed) in a state where a subject is positioned in a focus area set in the angle of view, focusing is automatically achieved and the focus locks. By such one-shot AF, focusing can be automatically achieved on a stationary subject. In the one-shot AF, however, in the case where the subject moves after completion of the focus lock, it is necessary to perform framing again to position the subject in the focus area and lock the focus. By the one-shot AF, therefore, it is difficult to finish photographing a moving subject in short time. The user often misses an opportunity for a good picture of a subject. The one-shot AF is not suitable as an AF control of a digital camera for taking a movie.

A technique of continuously maintaining focusing on a moving subject in order to solve the drawbacks of the one-shot AF also exists. For example, a technique of continuous AF (servo AF) for continuously maintaining focus by driving a focus lens near the infocus lens position of a latest timing and, at the moment the shutter button is pressed, stopping the focus lens and a technique (Japanese Patent Application Laid-Open No. 2000-214522) of changing the position of a focus area in accordance with movement of a subject are known. According to the techniques, it becomes easier to continuously maintain focusing on a moving subject, so that the user can catch an opportunity to take a good picture of the moving subject.

In the above technique, however, operability and usability in the case where focusing cannot be maintained due to an unexpected movement of a subject, camera shake, and the like are not sufficiently considered. For example, in the technique disclosed by Japanese Patent Application Laid-Open No. 2000-214522, when focusing becomes unmaintainable, detection of the subject is performed again from the beginning. Consequently, in the conventional techniques, when focusing becomes unmaintainable, it takes long time to re-achieve focusing and it makes the user feel strange.

### SUMMARY OF THE INVENTION

The present invention is directed to an image capturing apparatus.

According to a first aspect of the present invention, an image capturing apparatus for capturing image data on the basis of a light image acquired by an optical system, includes: a focusing member for achieving focus by moving the optical system to an infocus position; and a controller for moving a position of a focus area which is set in an image formed by the light image so that the focus area includes a main subject, determining a present focus position from a plurality of pieces of information in the focus area, obtained by driving the optical system around a reference position determined on the basis of a prior infocus position, and moving the optical system to the present infocus position by controlling the focusing member. At the time of losing track of the main subject during its control, the controller continues to drive the optical system around a reference position determined on the basis of the latest infocus position.

According to the image capturing apparatus, when the track of the main subject is lost, the optical system is not largely driven. Thus, the possibility of re-achieving focusing on the main subject in short time can be increased.

According to a second aspect of the present invention, an image capturing apparatus includes: an optical system for capturing a light image including a subject; a driver for driving a focus lens of the optical system; an image sensor for converting the light image into image data; a renewing part for renewing the position of a focus area set in an image in which the image data is obtained on the basis of movement of the subject; a controller for controlling the driver on the basis of image information in the focus area to move the focus lens to an infocus lens position in which a focusing state can be achieved; and a selector capable of switching a control mode of the controller between (1) a first control mode of specifying a present infocus lens position from the image information obtained by driving the focus lens around a reference lens position determined on the basis of a prior infocus lens position, and (2) a second control mode of specifying a present infocus lens position independently of the prior infocus lens position. When the present infocus lens position becomes unspecified during control in the first control mode, control in the first control mode is continued.

In the image capturing apparatus, also in the case where the infocus lens position cannot be specified, the focus lens is not largely driven. Thus, the possibility of re-achieving focusing on the subject in short time can be increased.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a digital camera 1A;

FIG. 2 is a cross-sectional view taken along line D-D of FIG. 1;

FIG. 3 is a rear view of the digital camera 1A;

FIG. 4 is a schematic block diagram showing the internal configuration of the digital camera 1A;

FIG. 5 is a diagram showing a focus area R provided in an image ID for display;

FIG. 6 is a graph showing the relation between lens positions P₁ to P₃ and contrast values C₁ to C₃;

FIG. 7 is a graph showing the relation between the lens positions P₁ to P₃ and the contrast values C₁ to C₃;

FIG. 8 is a graph showing the relation between the lens positions P₁ to P₃ and the contrast values C₁ to C₃;

FIG. 9 is a diagram for describing a method of detecting movement of a main subject;

FIG. 10 is a flowchart for describing operations of a one-shot AF control;

FIG. 11 is a graph showing a change in the lens position in the one-shot AF control;

FIG. 12 is a time chart for describing the operation of pattern drive AF control;

FIG. 13 is a flowchart for describing the operation of the pattern drive AF control;

FIG. 14 is a diagram showing an icon ICN superimposed on the image ID for display;

FIG. 15 is a time chart for describing whole AF control of the digital camera 1A;

FIG. 16 is a time chart for describing the whole AF control of the digital camera 1A;

FIG. 17 is a diagram for describing layout of local focus areas RB₁ to RB₅ provided in the image ID for display;

FIG. 18 is a diagram showing local focus areas RBⱼ and RBₖ;

FIG. 19 is a time chart for describing whole AF control of a digital camera 1B;

FIG. 20 is a time chart for describing the whole AF control of the digital camera 1B;

FIG. 21 is a diagram showing layout of a wide focus area WR and sub focus areas WR(1) to WR(9) provided in the image ID for display;

FIG. 22 is a time chart for describing the whole AF control of a digital camera 1C; and

FIG. 23 is a time chart for describing the whole AF control of the digital camera 1C.

### DESCRIPTION OF THE PREFERRED EMBODIMENTS

First Preferred Embodiment

External Configuration of Digital Camera 1A

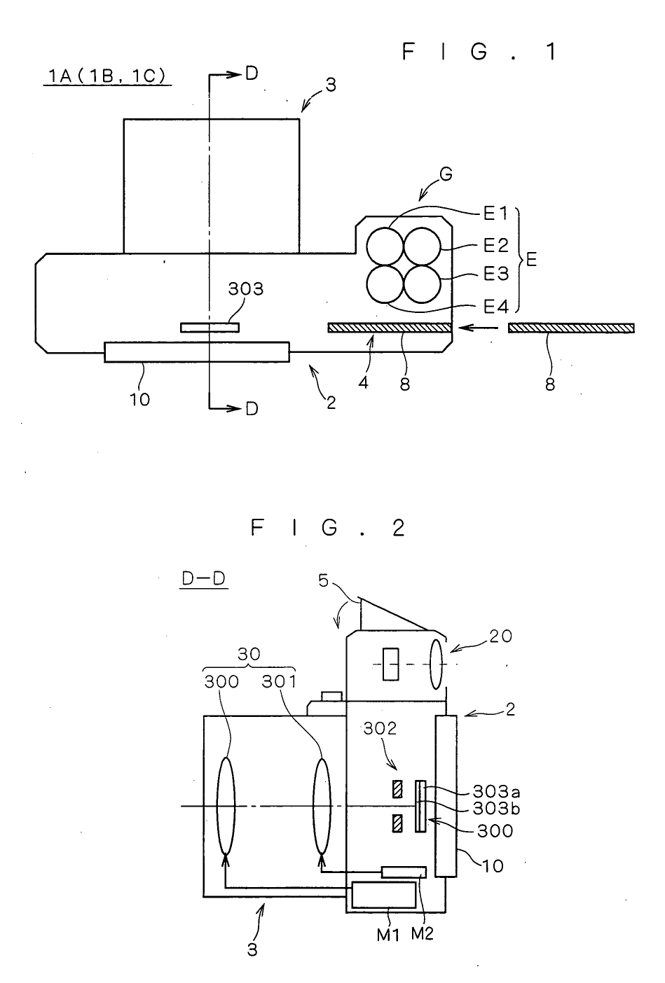

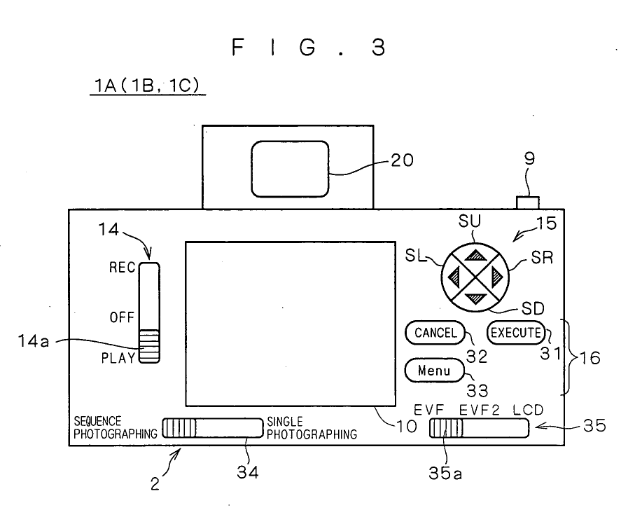

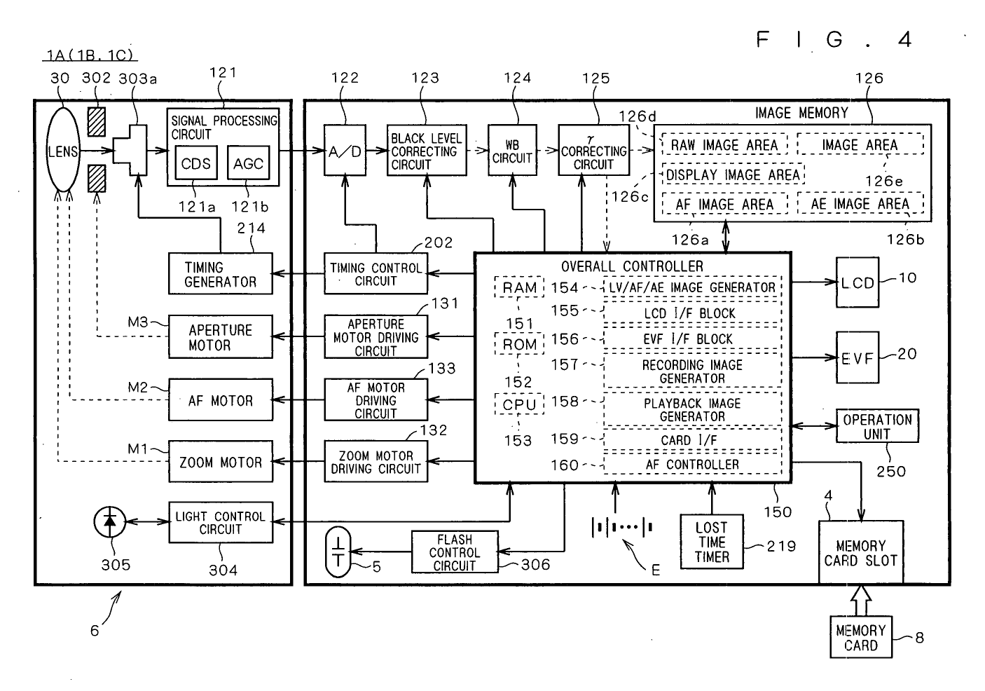

The external configuration of a digital camera 1A according to a first preferred embodiment of the present invention will be described with reference to FIGS. 1 to 3. FIG. 1 is a plan view of the digital camera 1A. FIG. 2 is a cross-sectional view taken along line D-D of FIG. 1. FIG. 3 is a rear view of the digital camera 1A.

As shown in FIGS. 1 to 3, the digital camera 1A is constructed by a camera body 2 having an almost rectangular parallelepiped shape and a taking lens 3 which can be attached/detached to/from the camera body 2.

As shown in FIG. 1, a memory card slot 4 in which a memory card 8 for recording a captured image is housed is provided in the camera body 2. The memory card 8 is removably housed in the memory card slot 4. The digital camera 1A uses a power supply battery E as a operation power supply source in which four AA cells E1 to E4 contained in the camera body 2 in an exchangeable manner are connected in series.

As shown in FIG. 2, the taking lens 3 has a lens group 30 including a zoom lens unit 300 and a focus lens unit 301. In FIG. 2, each of the zoom lens unit 300 and focus lens unit 301 is shown as a single lens. In practice, each of the lens units 300 and 301 is a lens unit of a plurality of lenses.

The camera body 2 has therein a zoom motor M1 for driving the zoom lens unit 300 to the change zoom magnification of the taking lens 3 and an AF motor M2 for driving the focus lens unit 301 to change a focus state.

A color image capturing device 303 having a photoreceiver in which photoelectric conversion cells are arranged is provided rearward of the lens group 30 of the taking lens 3. The color image capturing device 303 takes the form of a single-plate color area sensor in which color filters 303b of R (red), G (green) and B (blue) are adhered in a checker pattern on the surface of pixels of an area sensor formed by a CCD (Charge Coupled Device) 303a. The CCD 303a has, for example, 1920000 pixels constructed by 1600 pixels horizontally by 1200 pixels vertically. An aperture stop 302 is provided in front of the color image capturing device 303 to change an amount of light entering the color image capturing device 303.

As shown in FIG. 1, in the front face of the camera body 2, a grip part G is provided.

As shown in FIG. 2, a pop-up-type built-in flash 5 is provided at an upper end of the camera body 2. As shown in FIG. 3, a shutter start button 9 is provided on the top face of the camera body 2. The shutter start button 9 has the function of detecting a partway pressed state (hereinafter, referred to as an “S1 state”) used as a trigger for focus adjustment or the like and an all the way pressed state (hereinafter, referred to as an “S2 state”) used as a trigger for image capture for recording.

On the rear face of the camera body 2, a liquid crystal display (hereinafter, abbreviated as “LCD”) 10 and an electronic viewfinder (hereinafter, “EVF”) 20 are provided. The LCD 10 and EVF 20 have the function of a finder for displaying a live view (LV) of image signals from the CCD 303a in standby state. In addition, in a recording mode of capturing an image and recording the captured image into a memory card, the LCD 10 can display a menu screen for setting an image capturing mode, image capturing conditions and the like and can display an icon for making the user recognize that focusing is not achieved. In a playback mode of playing back the captured image, the LCD 10 can play back the captured image which is recorded on the memory card 8.

A recording/playback mode switch 14 is provided in the left part of the rear face of the camera body 2. The recording/playback mode switch 14 serves as a mode setting switch for switching and setting a recording mode and a playback mode and also serves as a power switch. Specifically, the power switch 14 is a three-position slide switch capable of changing an electric connection state in three ways by changing the position of a knob 14a. When the knob 14a is set in the center position of “OFF”, the power is turned off. When the knob 14a is set in the upper “REC” position, the power is turned on and the digital camera 1A enters a recording mode. When the knob 14a is set in the lower “PLAY” position, the power is turned on and the digital camera 1A enters the playback mode.

In the right part of the rear face of the camera body 2, a four-way switch 15 is provided. The user of the digital camera 1A can perform various operations of the digital camera 1A by depressing buttons SU, SD, SL and SR in the four ways of up, down, left and right which construct the four-way switch 15. For example, the user can change a selected item on a menu screen or change a frame to be played back selected on an index screen on which a list of captured images recorded on the memory card 8 by depressing the buttons SU, SD, SL and SR in a predetermined way. In the recording mode, the buttons SR and SL in the right and left ways also function as a switch for changing the zoom magnification of the taking lens 3. Concretely, when the button SR is depressed in the recording mode, the zoom lens unit 300 is driven by the zoom motor M1 and the zoom magnification is continuously changed to the wide angle side. On the other hand, when the button SL is depressed in the recording mode, the zoom lens unit 300 is driven by the zoom motor M1 and the zoom magnification is continuously changed to the telephoto side.

Below the four-way switch 15, a switch group 16 consisting of an execution switch 31, a cancel switch 32 and a menu display switch 33 is provided. The execution switch 31 is a switch for determining selection of an item selected on a menu screen or executing the selected item. The cancel switch 32 is a switch for canceling the item selected on the menu screen. The menu display switch 33 is a switch for displaying the menu screen on the LCD 10 or switching the contents of the menu screen.

In the lower part of the rear face of the camera body 2, a single/sequential photographing switch 34 for switching a mode between a single photographing mode and a sequential photographing mode and an LCD/EVF switch 35 for selecting display means are provided. The LCD/EVF switch 35 is a three-position slide switch like the recording/playback mode switch 14. When a knob 35a is set in an “EVF” position at the left, display of the EVF 20 is turned on. When the knob 35a is set in an “LCD” position at the right, display of the LCD 10 is turned on. When the knob 35a is set in an “EVF2” in the center, in response to approach of the user's eyes, display of the EVF 20 is turned on.

Internal Configuration of Digital Camera 1A

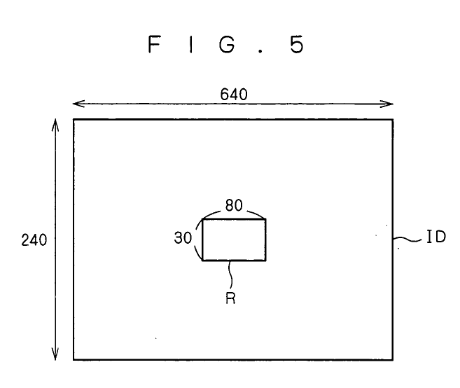

The internal configuration of the digital camera 1A will now be described with reference to FIG. 4. FIG. 4 is a schematic block diagram showing the internal configuration of the digital camera 1A.

Internal Configuration of Digital Camera

The CCD 303a photoelectrically converts a light image of a subject formed by the lens group 30 into image signals of color components of R (red), G (green) and B (blue) (signals each constructed by a signal train of pixel signals generated by each of pixels by reception of light), and outputs the image signal.

Exposure control in an image capturing unit 6 is performed by adjusting the aperture stop 302 and exposure time of the CCD 303a, that is, charge accumulation time of the CCD 303a corresponding to the shutter speed. The aperture stop 302 is adjusted by being driven by an aperture motor M3. In the case where shutter speed and aperture value achieving proper exposure cannot be set due to an insufficient amount of light from the subject, by performing level adjustment on an image signal outputted from the CCD 303a, improper exposure due to exposure insufficiency is corrected. The level adjustment of an image signal is performed by gain control of an automatic gain control (AGC) circuit 121b in a signal processing circuit 121.

A timing generator 214 generates various drive control signals for controlling driving of the CCD 303a. The digital camera 1A can read an image signal generated by the CCD 303a synchronously with the drive control signal generated by the timing generator 214. The timing generator 214 generates a drive control signal of the CCD 303a on the basis of a reference clock transmitted from a timing control circuit 202. The timing generator 214 generates clock signals such as, for example, a timing signal of start/end of integration (start/end of exposure) and read control signals (horizontal sync signal, vertical sync signal, transfer signal and the like) of charges accumulated on pixels and outputs the signals to the CCD 303a.

The timing control circuit 202 for generating clock signals which specify operation of the timing generator 214 and A/D converter 122 is controlled by a reference clock signal outputted from an overall controller 150.

The signal processing circuit 121 performs a predetermined analog signal process on an image signal (analog signal) outputted from the CCD 303a. The signal processing circuit 121 has a CDS (Correlated Double Sampling) circuit 121a and the AGC circuit 121b. The CDS circuit 121a reduces noise of an image signal, and the AGC circuit 121b adjusts the level of the image signal by adjusting the gain of itself.

A light control circuit 304 is provided to control a light emission amount of the built-in flash 5 at the time of photographing with flash to a predetermined light emission amount which is set by the overall controller 150. At the time of photographing with flash, simultaneously with exposure start, reflection light from the subject of flash light is received by a sensor 305. When it is detected that the light reception amount in the sensor 305 reaches a predetermined light amount, the light control circuit 304 outputs a light emission stop signal to the overall controller 150. By outputting a control signal to a flash control circuit 306 in response to the light emission stop signal, the overall controller 150 forcedly stops supply of power to the built-in flash 5. By the operations, the light emission amount of the built-in flash 5 is controlled to a predetermined light emission amount.

The zoom motor M1, the AF motor M2 and the aperture motor M3 are driven by the power supplied from a zoom motor driving circuit 132, an AF motor driving circuit 133 and an aperture motor driving circuit 131, respectively. The zoom motor driving circuit 132, the AF motor driving circuit 133 and the aperture motor driving circuit 131 supply power to the zoom motor M1, the AF motor M2 and the aperture motor M3, respectively, on the basis of a control signal supplied from the overall controller 150.

An A/D converter 122 converts each of pixel signals constructing an image signal into a digital signal of 12 bits. The A/D converter 122 converts each pixel signal (analog signal) into a digital signal of 12 bits on the basis of a clock signal for A/D conversion supplied from the timing control circuit 202.

A black level correcting circuit 123 corrects the black level of the A/D converted pixel signal into a reference black level.

A white balance (WB) circuit 124 performs level conversion of a pixel signal of each of color components of R, G and B. The WB circuit 124 converts the level of a pixel signal of color components of R, G and B by using a level conversion table supplied from the overall controller 150. A conversion coefficient (gradient of characteristics) of each of the color components of the level conversion table is set for each captured image by the overall controller 150.

A γ correcting circuit 125 corrects the γ characteristic of pixel data.

An image memory 126 is a memory for temporarily storing various image data generated by the digital camera 1A. The overall controller 150 organically controls the operations of the components of the digital camera 1A, thereby controlling the operation of the digital camera 1A in a centralized manner.

A lost time timer 219 is provided to count elapsed time since focusing on a subject became unmaintainable in the AF control of the digital camera 1A. The details of the lost time timer 219 will be described later.

An operation unit 250 includes the above-described various switches and buttons.

Overall Controller 150

The overall controller 150 is a microcomputer having, at least, a RAM 151, a ROM 152 and a CPU 153. A centralized control of the overall controller 150 is executed by the CPU 153 on the basis of a program stored in the ROM 152.

In the overall controller 150 in FIG. 4, function blocks expressing functions realized by hardware such as the RAM 151, ROM 152 and CPU 153 are shown. In the following, the function blocks will be described.

The overall controller 150 has an AF controller 160 and an AE controller (not shown) as function blocks for performing AF control and AE control.

Further, the overall controller 150 has the recording image generator 157 for generating thumbnail image data and compressed image data to be recorded on the memory card 8 from raw image. The raw image denotes herein an image subjected to predetermined signal processes by the A/D converter 122, black level correcting circuit 123, WB circuit 124 and y correcting circuit 125 at the time of image capturing by the digital camera 1A. The recording image generator 157 generates compressed image data by performing a predetermined compressing process according to a JPEG method such as two-dimensional DCT, Huffman coding or the like on raw image data, and records the compressed image data into an image area 126e. The image data recorded in the image area 126e is transferred to a card I/F 159 and recorded on the memory card 8.

The overall controller 150 also has a playback image generator 158 for generating playback image data which is played back on the LCD 10 or EVF 20 from the image data recorded on the memory card 8.

The overall controller 150 also has the card I/F 159 as an interface for writing/reading image data to/from the memory card 8.

Image Memory 126

The image memory 126 is a memory for storing image data outputted from the γ correcting circuit 125. In the image memory 126, an AF image area 126a for storing an image for AF computation, an AE image area 126b for storing an image for automatic exposure (AE) computation, a display image area 126c for storing a display image to be displayed on the LCD 10 or EVF 20, a raw image area 126d for storing raw image, and the image area 126e for storing an image are set in accordance with an operation state of the camera.

The display image ID is an image having 640×240 pixels constructed by pixel data obtained by reducing the number of pixels of all-pixel data. The display image ID is generated by an LV/AF/AE image generator 154.

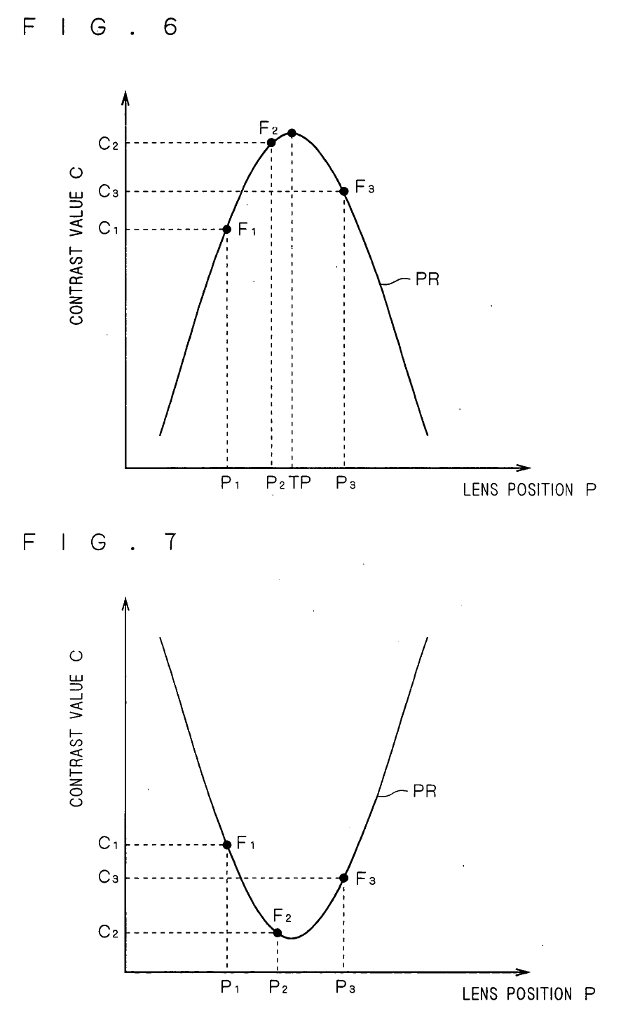

The AF image is, as shown in FIG. 5, a partial image having 80×30 pixels set in the display image ID having 640×240 pixels. The AF control of the digital camera 1A is performed by the AF controller 160 in the overall controller 150 on the basis of the image information of this AF image. The position of the AF image in the display image ID is set by the LV/AF/AE image generator 154 in the overall controller 150. The set position of the AF image is stored in the RAM 151 in the overall controller 150. In the following, an area for an AF image provided in the display image ID will be referred to as a focus area R, and the set position of the AF image (represented by a center point of the focus area) will be referred to as a focus area position.

The AE image is an image of 40×240 pixels obtained by adding 16 pixels to each of R, G and B of pixel data of the display image ID having 640×240 pixels. The AE image is generated by the LV/AF/AE image generator 154.

Outline of Operation of Digital Camera 1A

An outline of the operation of the digital camera 1A will now be described.

Standby State

In the standby state in the recording mode of the digital camera 1A, predetermined signal processes are performed by the A/D converter 122, black level correcting circuit 123, WB circuit 124, and γ correcting circuit 125 are performed on each pixel data of images captured at a predetermined frame rate (in this case, 33 millisecond) by the image capturing unit 6. Further, the pixel data subjected to the signal processes is transferred as image data to the LV/AF/AE image generator 154. The LV/AF/AE image generator 154 generates the display image ID, AF image and AE image from the transferred image data and stored the generated images into the display image area 126c, AF image area 126a and AE image area 126b.

In the case where the LCD 10 is selected by the LCD/EVF switch 35, the image data stored in the display image area 126c is transferred to an LCD I/F block 155 in the overall controller 150. In the case where the EVF 20 is selected by the LCD/EVF switch 35, the image data is transferred to an EVF I/F block 156 in the overall controller 150. The image data subjected to the predetermined process in the LCD I/F block 155 or EVF I/F block 156 is transferred to the LCD 10 or EVF 20 and visibly displayed. The user of the digital camera 1A can perform framing for photographing while visually recognizing the subject displayed.

S1 State

When the user sets the shutter start button 9 into the S1 state in the standby state, the digital camera 1A starts an AF control. Specifically, the digital camera 1A performs a control of driving the position of the focus lens unit 301 (hereinafter, simply referred to as “lens position”) to a lens position where a focus evaluation value of the AF image becomes the maximum (hereinafter, simply referred to as “focus lens position”). The focus evaluation value is not particularly limited as long as it is an amount indicative of a focus state. For example, a contrast value or the like can be employed as the focus evaluation value. In the digital camera 1A, a control of changing the focus area position so as to trace the movement of a main subject is performed (hereinafter, simply referred to as “automatic tracking control”). The processes are performed by the AF controller 160. The details of the AF control will be described later.

In the S1 state, the digital camera 1A determines a shutter speed and an aperture value on the basis of the level of the AE image and determines a white balance correction value. The processes are performed by the AE controller.

S2 State

When the shutter start button 9 enters the S2 state from the S1 state, the digital camera 1A stores the raw image data subjected to the predetermined processes into the raw image area 126d. Subsequently, the raw image data is transferred to the recording image generator 157 and subjected to JPEG compression at a compression ratio set by the user on the menu screen. To the compressed image, information such as tag information regarding a captured image (frame number, exposure value, shutter speed, compression ratio, date of photographing, data indicative of the on/off state of flash at the time of photographing, scene information, results of check of the image, and the like) is added. The image data subjected to the processes is temporarily stored in the image area 126e and, after that, stored into the memory card 8 via the card I/F 159.

Playback Mode

In the playback mode of the digital camera 1A, first, image data of the largest frame number in the memory card 8 is read by the card I/F block 159. The read image data is transferred to the playback image generator 158. The playback image generator 158 performs a process of decompressing the image data transferred and stores the decompressed image data into the display image area 126c. The image data stored in the display image area 126c is, as described above, subjected to the predetermined process in the LCD I/F block 155 or EVF I/F block 156, and the processed image data is displayed on the LCD 10 or EVF 20. In such a manner, the image of the largest frame number, that is, the image captured most lately is displayed on the LCD 10 or EVF 20. The image displayed on the LCD 10 or EVF 20 is renewed to an image of smaller frame number each time the button SD is depressed. Each time the button SU is depressed, the image is renewed to an image of larger frame number.

AF Control of Digital Camera 1A

The AF controller 160 of the digital camera 1A performs the AF control in accordance with the program stored in the ROM 152. The program includes two sub programs corresponding to the one-shot AF control and pattern drive AF control. The AF controller 160 can be used while switching the control between the one-shot AF control and the pattern drive AF control. The one-shot AF control is an AF control in which history up to the present time point of the lens position is not considered. The pattern drive AF control is an AF control in which history up to the present time point of the lens position is considered. In each of the one-shot AF control and the pattern drive AF control, a focus lens position in which the infocus state is obtained is calculated on the basis of three different lens positions and contrast values as focus evaluation values in the lens positions. In the following, a method of calculating the infocus lens position will be described first. After that, concrete controls of the one-shot AF control and the pattern drive AF control will be described. Method of calculating focus lens position

An infocus lens position FP is calculated from three different lens positions P₁ to P₃ (P₁<P₂<P₃) and contrast values C₁ to C₃ of AF images (that is, an image in the focus frame R) in the lens positions P₁ to P₃. More concretely, the infocus lens position FP is calculated by Equation 1.

$$FP = \frac{{C}_{1} ( {P}_{3}^{2} - {P}_{2}^{2} ) + {C}_{2} ( {P}_{1}^{2} - {P}_{3}^{2} ) + {C}_{3} ( {P}_{2}^{2} - {P}_{1}^{2} )}{2 \{ {C}_{1} ( {P}_{3} - {P}_{2} ) + {C}_{2} ( {P}_{1} - {P}_{3} ) + {C}_{3} ( {P}_{2} - {P}_{1} ) \}} \qquad Equation 1$$

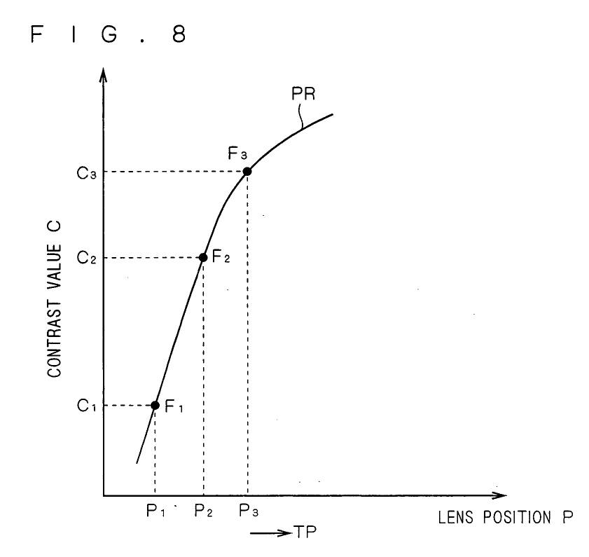

In calculation of the infocus lens position FP in Equation 1, it is assumed that the contrast value C is expressed by a quadratic function of the lens position P. The lens position P at which the quadratic function satisfying the relation between the lens positions P₁ to P₃ and the contrast values C₁ to C₃ becomes the maximum value is specified as the infocus lens position FP. The relation is shown in each of graphs of FIGS. 6 to 8. In FIGS. 6 to 8, the lateral axis denotes the lens position P, and the vertical axis denotes the contrast value C. The smaller value of the lens position P corresponds to the near side and the larger value of the far side. In each of FIGS. 6 to 8, the relation between the lens positions P₁ to P₃ and the contrast values C₁ to C₃ are plotted as points F₁, F₂ and F₃, respectively, and the quadratic function is expressed as a parabola PR passing the points F₁, F₂ and F₃. As shown in the graph of FIG. 6, in the case where the parabola PR opens downwards and a lens position TP corresponding to the vertex of the parabola PR is within the range shown by Equation 2, the lens position TP is the infocus lens position FP.
P₁<TP<P₃ Equation 2

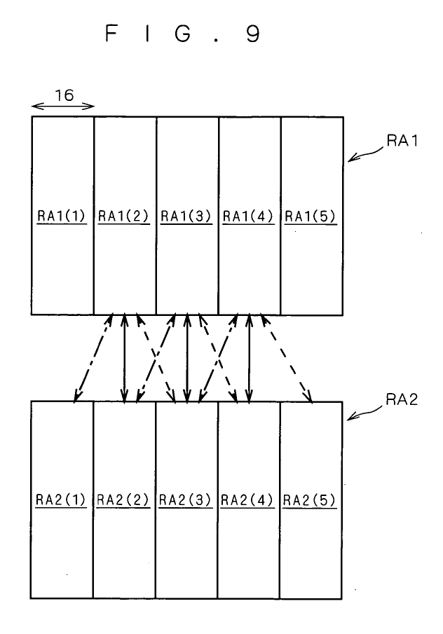

In the case where, as shown in the graph of FIG. 8, the lens position TP in which a function indicative of the parabola PR is the maximum value is out of the range expressed by Equation 2 (in the case where the function indicative of the parabola PR monotonously increases or decreases in the range expressed by Equation 2), the AF controller 160 determines that the focus lens unit 301 is away from the infocus lens position FP. As shown in the graph of FIG. 7, in the case where the parabola PR opens upwards, the maximum value cannot be defined for a some reason such as coexistence of near and far objects. In this case, the AF controller 160 determines that the focus lens unit 301 is away from the infocus lens position FP. A case such that the focus lens unit 301 changes from the state in which the focus lens unit 301 is near the infocus lens position FP to the state where the focus lens unit 301 is away from the infocus lens position FP will be referred to as “loss of a subject” in the following description.

Automatic Tracking Control

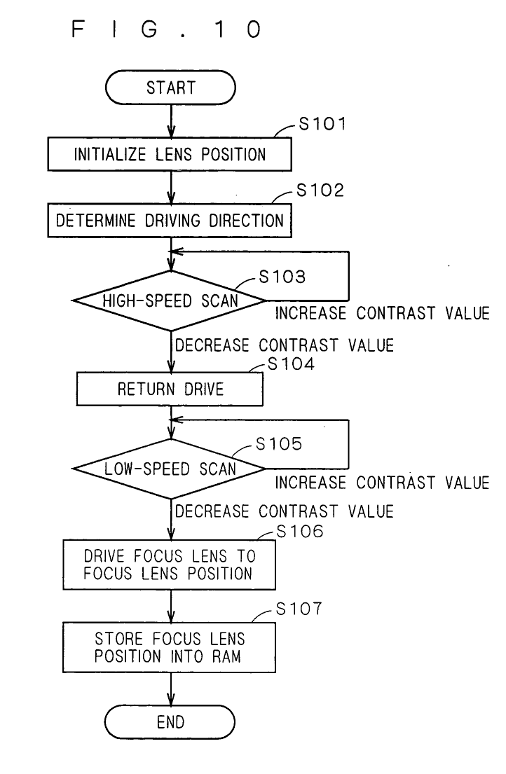

In the digital camera 1A, as described above, the automatic tracking control of changing the focus area position so as to trace movement of a main subject is performed. The automatic tracking control will be described with reference to FIG. 9. In the automatic tracking control of the digital camera 1A, movement in both the lateral direction and the vertical direction of a main subject can be detected. Since a method of detecting movement in the lateral direction and that in the vertical direction are the same in theory, in the following, only the method of detecting movement in the lateral direction will be described, and the method of detecting movement in the vertical direction will not be described.

FIG. 9 is a diagram for describing the method of detecting movement of a main subject. In FIG. 9, a focus area RA1 in the n-th frame FLₙ and a focus area RA2 in the (n+1)th frame FLₙ₊₁ are shown so as to be compared with each other.

In order to detect movement of the main subject between the frames FLₙ and FLₙ₊₁, first, the AF controller 160 equally divides each of the focus areas RA1 and RA2 in the lateral direction, thereby generating divided areas RA1(1) to RA1(5) and RA2(1) to RA2(5) each consisting of 16×30 pixels. Further, the AF controller 160 calculates brightness values BA1(1) to BA1(5) and BA2(1) to BA2(5) each as an average of each of the divided areas RA1(1) to RA1(5) and RA2(1) to RA2(5). The calculated brightness values BA1(1) to BA1(5) and BA2(1) to BA2(5) are stored in the RAM 151.

After that, the AF controller 160 obtains the brightness value difference between two divided areas to which attention is paid and compares the brightness value differences with respect to the divided areas RA1(1) to RA1(5) and RA2(1) to RA2(5), thereby determining whether the main subject has moved or not. For example, the AF controller 160 compares following total (a) with total (b). The total (a) is the total of the brightness value difference between the divided areas RA1(2) and RA2(2), the brightness value difference between the divided areas RA1(3) and RA2(3), and the brightness value difference between the divided areas RA1(4) and RA2(4) (corresponding to solid lines in FIG. 9). The total (b) is the total of the brightness value difference between the divided areas RA1(2) and RA2(3), the brightness value difference between the divided areas RA1(3) and RA2(4), and the brightness value difference between the divided areas RA1(4) and RA2(5) (corresponding to broken lines in FIG. 9). When the latter total (b) of the brightness difference values is smaller than the former total (a), it is determined that the main subject has moved to the right by an amount of 16 pixels.

Similarly, the AF controller 160 compares following total (c) with total (d). The total (c) is the total of the brightness value difference between the divided areas RA1(2) and RA2(2), the brightness value difference between the divided areas RA1(3) and RA2(3), and the brightness value difference between the divided areas RA1(4) and RA2(4) (corresponding to solid lines in FIG. 9). The total (d) is the total of the brightness value difference between the divided areas RA1(2) and RA2(1), the brightness value difference between the divided areas RA1(3) and RA2(2), and the brightness value difference between the divided areas RA1(4) and RA2(3) (corresponding to dash-dotted lines in FIG. 9). When the latter total (d) of the brightness difference values is smaller than the former total (c) of the brightness difference values, it is determined that the main subject has moved to the left by an amount of 16 pixels.

When the movement of the main subject is detected, the AF controller 160 renews the focus area position AP stored in the RAM 151 so as to trace the movement. For example, when the AF controller 160 determines that the main subject has moved to the left or right by an amount of 16 pixels, the focus area position AP is changed to the left or right by 16 pixels and the renewed focus area position AP is overwritten on the RAM 151. The focus area position AP renewed in such a manner is reflected in the AF control from the (n+2)th frame FLₙ₊₂. Since the focus area position AP changes so as to trace the movement of the main subject, focusing on the main subject can be easily achieved.

One-Shot AF Control

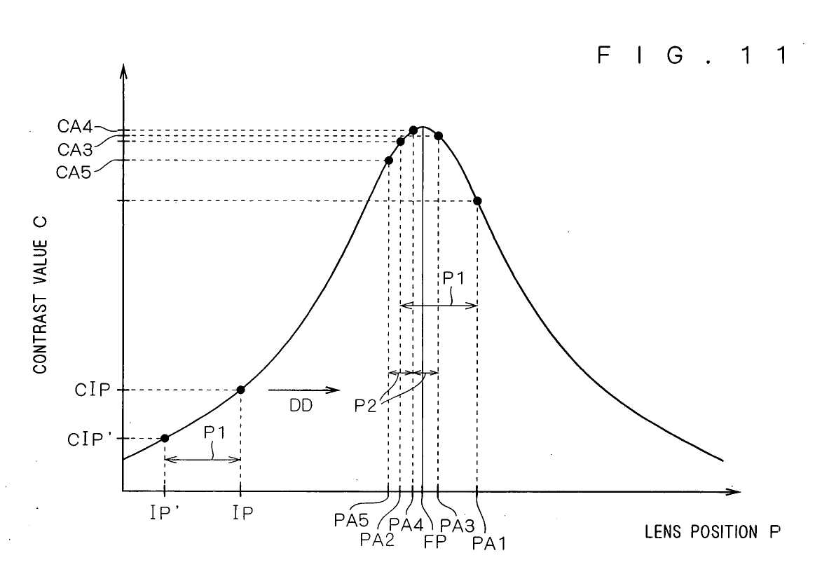

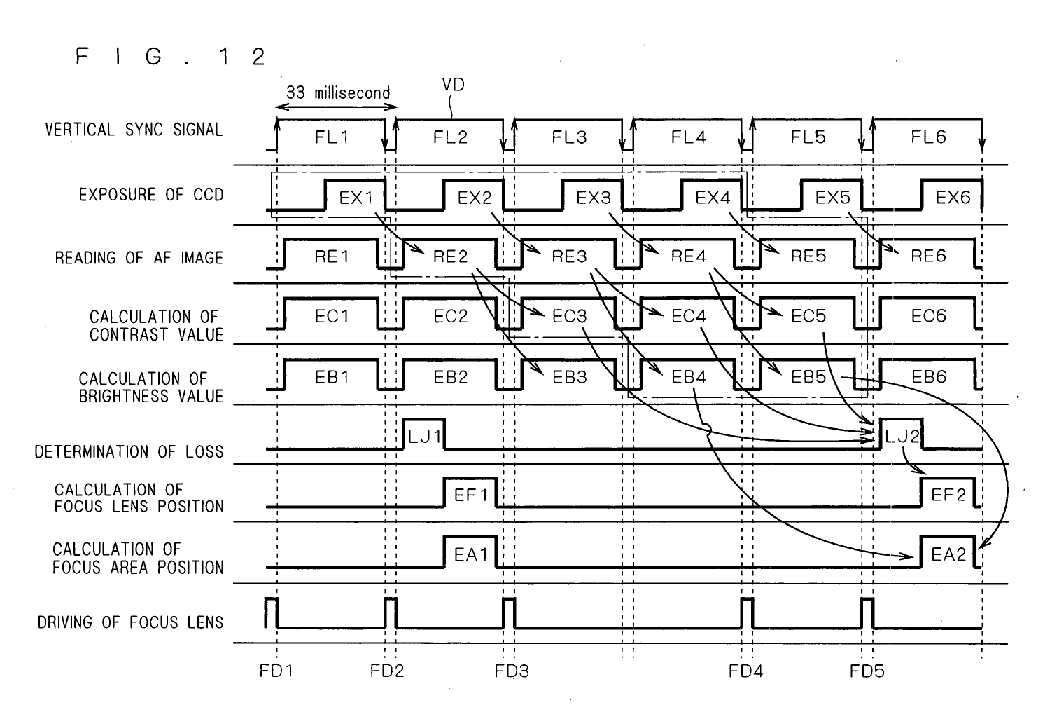

In the following, the one-shot AF control will be concretely described. In the one-shot AF control, the AF controller 160 performs a feedback control realizing focusing by evaluating a contrast value C of an AF image while changing the lens position P and driving the focus lens unit 301 so as to increase the contrast value C. In the following, the control will be referred to as “video servo” for the sake of convenience. The AF control by the video servo will be described with reference to the flowchart of FIG. 10 and the graph of FIG. 11. In the one-shot AF control, the position of the focus area R for generating an AF image is fixed.

FIG. 11 is a graph showing a change in the contrast value C in accordance with the lens position P. In the graph of FIG. 11, the lateral axis indicates the lens position P and the vertical axis indicates the contrast value C. The smaller value side of the lens position P corresponds to the near side, and the larger value side of the lens position P corresponds to the far side. The graph of FIG. 11 shows that the contrast value C becomes the maximum at the infocus lens position FP. Since the graph of FIG. 11 is a graph for qualitatively showing movement of the lens position P in the video servo, the lens position P is not always quantitatively reflected in the coordinates on the graph.

In the first step S101 of the one-shot AF, the lens position P is initialized. Specifically, the AF controller 160 outputs a control signal to the AF motor driving circuit 133 to drive the focus lens unit 301 from the lens position at the present time point to the initial lens position IP. Since the initial lens position IP is a predetermined lens position, in the one-shot AF control, without considering the lens position in the past, the focus lens unit 301 is driven. After completion of the driving of the focus lens unit 301 to the initial lens position IP, the following step S102 is executed.

In step S102, the driving direction of the focus lens unit 301 in a high-speed scan executed in step S103 is determined. Concretely, the AF controller 160 outputs a control signal to the AF motor driving circuit 132 to drive the focus lens unit 301 from the initial lens position IP to a lens position IP′ on the near side only by a pitch p1 (for example, p1=12 F6). Further, the AF controller 160 calculates contrast values CIP and CIP′ in the lens positions IP and IP′, respectively. Further, the AF controller 160 determines the relation between the contrast values CIP and CIP′ and specifies the driving direction of the focus lens unit 301 in which the contrast value C increases. The thus specified driving direction is a driving direction DD of the focus lens unit 301 in the high-speed scan. In the example of the graph of FIG. 11, the contrast value C increases on the side farther than the initial lens position IP, so that the direction to the far side is the driving direction DD. Since the lens position P in which the contrast value C becomes the maximum is the infocus lens position FP, the driving direction DD is the driving direction in which the focus lens unit 301 approaches the infocus lens position FP.

In step S103, the high-speed scan of the focus lens unit 301 is executed. Specifically, the AF controller 160 outputs a control signal to the AF motor driving circuit 133 and drives the focus lens unit 301 in the driving direction DD only by the pitch p1. Further, the AF controller 160 calculates the contrast values C before and after driving of the focus lens unit 301 and determines the relation of the contrast values C. When the contrast value C decreases due to the driving, the AF controller 160 finishes the high-speed scan and moves to execution of the next step S104. In the case where the contrast value C increases due to the driving, the AF controller 160 executes step S103 again. By the operation, until the contrast value C decreases due to the driving, the high-speed scan, that is, driving of the focus lens unit 301 in the driving direction DD is continued. When the focus lens unit 301 reaches a lens position PA1 after the lens position FP in which the contrast value C becomes the maximum, repetition of step S103 is finished and the next step S104 is executed.

In step S104, the driving direction DD of the focus lens unit 301 is changed to the opposite direction. The focus lens unit 301 is driven back to a lens position PA2 away from the lens position PA1 only by the pitch p1. In other words, the focus lens unit 301 is driven to the side closer to the initial lens position IP than the infocus lens position FP (to the near side in FIG. 11) near the infocus lens position FP. After completion of the backward driving, the following step S105 is executed.

Since the focus lens unit 301 is moved to a position close to the infocus lens position FP in steps S103 and S104, in step S105, the AF controller 160 performs a low-speed scan for bringing the focus lens unit 301 closer to the infocus lens position FP by driving the focus lens unit 301 at a pitch p2 (for example, p2=4 Fδ) smaller than the pitch p1. Specifically, in step S105, the AF controller 160 sets the pitch of driving the focus lens unit 301 from the pitch p1 to the smaller pitch p2 and drives the focus lens unit 301 in a manner similar to step S103. When the contrast value C decreases due to the driving in a manner similar to step S103, the AF controller 160 finishes the low-speed scan and moves to execution of the next step S106. Specifically, when the focus lens unit 301 reaches a lens position PA3 after the lens position FP, repetition of step S105 is finished and the following step is executed. When the contrast value C increases due to the driving, step S105 is executed again. The contrast value C and the lens position P obtained in the low-speed scan in step S105 are temporarily stored in the RAM 151, and used to calculate the infocus lens position FP in step S106.

In step S106, from the lens position PA3, a lens position PA4 to the near side from the lens position PA3 only by the pitch p2, a lens position PA5 to the near side from the lens position PA4 only by the pitch p2, and the contrast values C3 to C5 in the lens positions PA3 to PA5, the infocus lens position FP is calculated by the above-described method. Specifically, from the contrast values C3 to C5 in the three lens positions PA3 to PA5 near the infocus lens position FP, the infocus lens position FP in which the contrast value C becomes the maximum is calculated. The AF controller 160 drives the focus lens unit 301 to the calculated infocus lens position FP.

In step S107 subsequent to step S106, the infocus lens position FP is stored as a reference lens position BP into the RAM 151. Then the one-shot AF control is finished. The details of the reference lens position BP will be described later.

By performing the driving of the focus lens unit 301 by the high-speed scan and the low-speed scan like in the above-described operation flow, high-speed and high-precision AF control can be realized.

In the one-shot AF control, when the operation flow is finished and the focus lens unit 301 is moved to the infocus lens position FP, the focus lens unit 301 is fixed at the lens position P (focus lock).

Since the focus lens unit 301 is driven without considering the lens position P in the past in the one-shot AF control, also in the case where the lens position P at the present time point is close to the infocus lens position FP, the focus lens unit 301 is forcedly driven to the initial lens position IP.

Pattern Drive AF Control

In the following, the pattern drive AF control will be described concretely. In the pattern drive AF control, like the one-shot AF control, a control of driving the focus lens unit 301 to the infocus lens position FP in which the contrast value C becomes the maximum is performed by the AF controller 160. In the pattern drive AF control, however, different from the one-shot AF control, the AF control is executed in consideration of the past infocus lens position FP. More concretely, in the pattern drive AF control, the AF control of making the focus lens unit 301 approach the infocus lens position FP at the present time point while driving the focus lens unit 301 so as to reciprocate around the reference lens position BP specified from the infocus lens position FP in the past is performed. In the first preferred embodiment, the reference lens position BP is the infocus lens position FP specified most lately. In the pattern drive AF control, different from the one-shot AF control, not only movement of the focus lens unit 301 but also the above-described automatic tracking control is executed. The pattern drive AF control includes a normal control state in which focusing on the subject is maintained and the reference lens position BP is continuously renewed and an extended control state in which focusing on the subject is not maintained and renewing of the reference lens position BP is interrupted. Details of pattern drive AF control

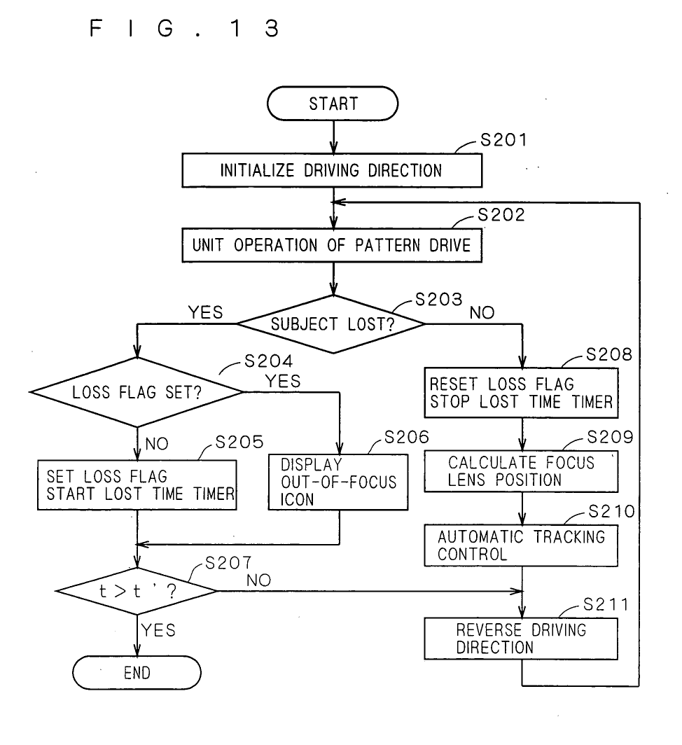

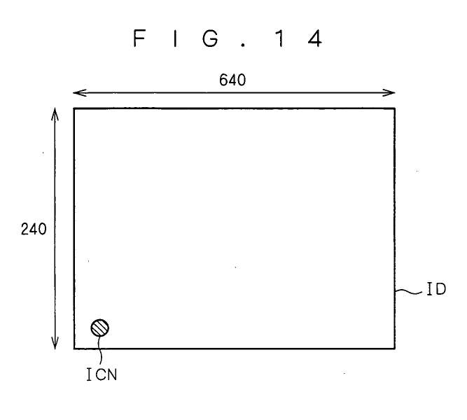

The pattern drive AF control will be described below with reference to the time chart of FIG. 12 and the flowchart of FIG. 13. In the time chart of FIG. 12, the lateral direction indicates time and the direction from the left to the right corresponds to lapse of time. In the time chart of FIG. 12, frame numbers FL1 to FL6 and vertical sync signals VD generated by the timing generator 214 are shown. The time chart also shows exposure timings EX1 to EX6 of the CCD 303a, timings RE1 to RE6 of reading an AF image from the CCD 303a, timings EC1 to EC6 of the contrast value C, brightness value calculating timings EB1 to EB6, loss determining timings LJ1 and LJ2, timings EF1 and EF2 of calculating the infocus lens position FP, timings EA1 and EA2 of calculating the focus area position AP, and timings FD1 to FD5 of driving the focus lens unit 301. Arrows on the time chart of FIG. 12 are lines schematically expressing the flow of image information to be processed.

The operation of the pattern drive AF control is executed synchronously with the vertical sync signal VD of 33 millisecond cycles. Specifically, the operation of the pattern drive AF control is executed on the frame unit basis. One frame corresponds to one cycle of the vertical sync signal VD. The frame numbers FL1 to FL6 are indices expressing the time-sequential order of the frames.

The digital camera 1A can process an image by a pipeline process. Specifically, the digital camera 1A can start processing the next image before completion of processing on an image. Consequently, before completion of a preceding process of step, the digital camera 1A can start a subsequent process of the step on the flowchart of FIG. 13. Therefore, in the order of steps of the flowchart of FIG. 13, the order with respect to time is not strictly reflected. The order of steps merely shows the concept of the flow of processes.

In the first step S201 of the pattern drive AF control, the driving direction DD of the focus lens unit 301 in a unit operation of the pattern drive in step S202 is initialized. The driving direction DD is stored in the RAM 151. The process of initializing the driving direction DD is performed when an initial driving direction DDO stored in the ROM 152 is transferred to the RAM 151. Although not limited, it is assumed herein that the initial driving direction DDO is a direction from the near side to the far side.

In step S202 executed after step S201, a pattern driving unit operation is performed for obtaining contrast values CB3 to CB5 necessary for specifying the infocus lens position FP at the present time point and brightness values BB4 and BB5 necessary for the automatic tracking control. The infocus lens position FP at the present time point is specified by driving the focus lens unit 301 around the reference lens position BP stored in the RAM 151. Since the reference lens position BP is the infocus lens position FP in the past, as the pattern drive AF control, by using the infocus lens position FP in the past as a temporary focus lens position, a control of specifying the infocus lens position FP at the present time point around the temporary infocus lens position FP. Such a control is effectively performed when a main subject is not moving largely.

Further, the details of the pattern drive unit operation will be described with reference to the time chart of FIG. 12. The pattern drive unit operation in step S202 includes processes of a region surrounded by a dash-dotted line on the time chart and the timings FD1 to FD3 of driving the focus lens unit. The pattern drive unit operation is continuously repeatedly executed. In the digital camera 1A, by the above-described pipeline process, before a pattern drive unit operation is completed, the next pattern drive unit operation is started.

In the pattern driven unit operation in step S202, first, the reference lens position BP and the focus area position AP stored in the RAM 151 are read by the AF controller 160. Subsequently, the AF controller 160 outputs a control signal to the AF motor driving circuit 133 to drive the focus lens unit 301 at the pitch p2 in the driving direction DD around the reference lens position BP. Further, the AF controller 160 calculates the contrast values CB3 to CB5 in lens positions PB1 to PB3 (which will be described later) from an image for AF having the center in the focus area position AP. The AF controller 160 calculates the brightness values BB4 and BB5 in the lens positions PB2 and PB3 from the image for AF having the center in the focus area position AP.

The pattern drive unit operation will be described more concretely. In the CCD 303a of the digital camera 1A, exposure is made once for each frame at each of the exposure timings EX1 to EX4. Charges accumulated on the CCD 303a by the exposure are read as an image signal in the next frame. Specifically, the charges accumulated on the CCD 303a by the exposure at the exposure timings EX1 to EX4 are read by the read timings RE2 to RE5, respectively. An image for AF is generated from the image signal in the same frame in which the charge is read. The AF controller 160 calculates the contrast value C and the brightness value B from the image for AF generated in the immediately preceding frame. To be specific, the AF controller 160 calculates the contrast values CB3 to CB5 of the image for AF generated at the read timings RE2 to RE4 at the calculation timings EC3 to EC5, respectively, and calculates the brightness values BB4 and BB5 of the image for AF generated at the read timings RE3 and RE4 at the calculation timings EB4 and EB5, respectively. The timings FD1 to FD3 of driving the focus lens unit 301 are prior to the exposure timings EX1 to EX3, so that the lens positions P at the exposure timings EX1 to EX3 are the lens position PB 1 to the near side than the reference lens position BP by the pitch p2, the reference lens position BP (lens position PB2), and the lens position PB3 on the far side than the reference lens position BP by the pitch p2. In such a manner, the CCD 303a is exposed at the three different lens positions PB1 to PB3 and the contrast values CB3 to CB5 are calculated. The contrast values CB3 to CB5 are used for calculating the infocus lens position FP at the present time point. The calculated brightness values BB4 and BB5 are used for the above-described automatic tracking control.

Subsequent to the pattern drive unit operation in step S202, step S203 is executed.

In step S203, “loss of a subject” is determined by the AF controller 160. The AF controller 160 determines whether or not the relations between the lens positions PB1 to PB3 and the contrast values CB3 to CB5 correspond to the loss of a subject in the above-described criteria. When the AF controller 160 determines that the relations correspond to the loss of a subject, step S204 is executed. When the AF controller 160 determines that the relations do not correspond to the loss of a subject, step S208 is executed. The determination of the loss is made at the loss determining timing LJ2 on the time chart.

Steps S204 to S207 to be described below are steps executed in the state where the subject is lost, that is, in the extended control state in which the reference lens position BP and the focus area position AP are not renewed.

In step S204, the process is branched depending on whether a loss flag as a status flag indicative of the loss of a subject is already set or not. If NO, that is, when the state where the subject is not lost changes to the state where the subject is lost, step S205 is executed. When the loss flag is already set, step S206 is executed. The loss flag is set in the RAM 151.

In step S205, the loss flag is newly set. Further, the lost time timer 219 for measuring continuation time “t” of the loss of the subject is started. After completion of start of the lost time timer 219, step S207 is executed.

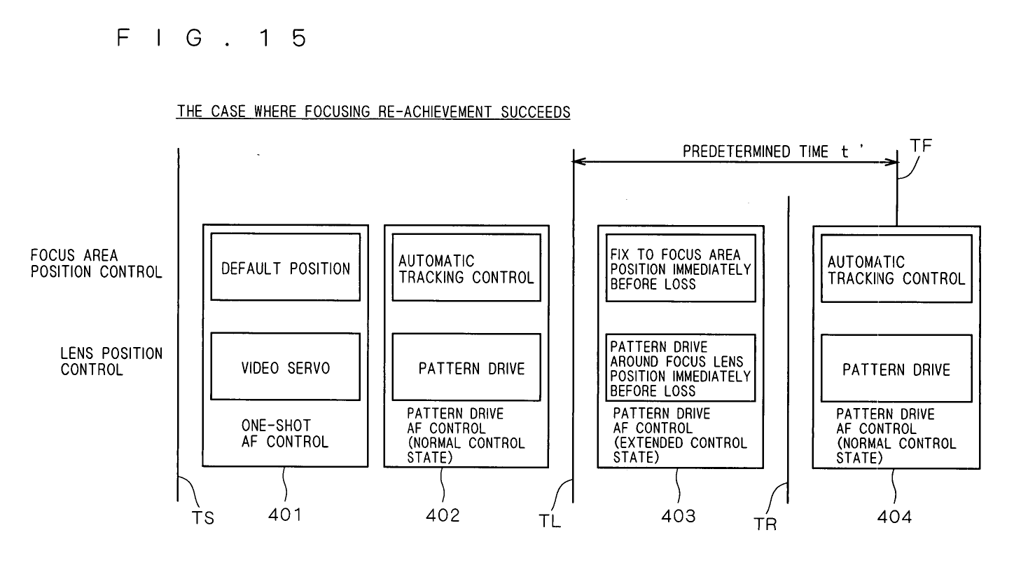

In step S206, an icon ICN for making the user recognize that focusing is not achieved is superimposed on the display image ID displayed on the LCD 10 or EVF 20. FIG. 14 shows an example of the display. By the icon ICN, the user can easily recognize the loss of a subject, so that necessity of re-framing can be known.

In step S207, a branching process is executed depending on the value of the lost time “t”. In the case where the lost time “t” is longer than predetermined time t′, the pattern drive AF control is finished. In the case where the lost time “t” is equal to or shorter than the predetermined time t′, the operation flow moves to step S211.

By the processes in steps S204 to S207, in the extended control state in which the loss of a subject is continued, the continuation time “t” is counted by the lost time timer 219.

Steps S208 to S210 described below are steps executed in the normal control state in which focusing on the main subject is maintained and the reference lens position BP is continuously renewed.

In step S208, the loss flag is reset and the lost time timer 219 is stopped.

In step S209, the infocus lens position FP at the present time point is calculated by the AF controller 160 from the lens positions PB1 to PB3 and contrast values CB3 to CB5 by the above-described method. The process in step 209 is executed at the timing EF2 of calculating the infocus lens position FP on the time chart. If the main subject has not moved since the past time point at which the reference lens position BP read in step S202 is calculated, the infocus lens position FP calculated in step S209 matches with the reference lens position BP. On the other hand, if the main subject has moved, the infocus lens position FP calculated in step S209 is different from the reference lens position BP. Therefore, by overwriting the infocus lens position FP calculated in step S209 as a new reference lens position BP on the RAM 151, the reference lens position BP stored in the RAM 151 is renewed in accordance with the movement of the main subject. The infocus lens position FP calculated in step S209 is reflected as the reference lens position FP calculated in the frame FL6 is reflected as a temporary focus lens position of the focus lens unit 301 in a not-shown frame FL9 and subsequent frames.

In step S210 subsequent to step S209, a process regarding the automatic tracking control is executed. Specifically, first, the AF controller 160 detects the movement of the main subject from the brightness values BB4 and BB5. The AF controller 160 renews the focus area position AP stored in the RAM 151 on the basis of the detected movement of the main subject. The process in step S210 is executed at the timing EA2 of calculating the focus area position AP on the time chart.

In step S211, the driving direction DD is changed to the opposite direction. When the driving direction DD at the present time point is a direction from the near side to the far side, the driving direction DD is changed to the opposite direction from the far side to the near side. When the driving direction DD at the present time point is a direction from the far side to the near side, the driving direction DD is changed to the opposite direction from the near side to the far side. After the reversing process is finished, the operation flow is returned to step S201 and the pattern drive AF control is continued.

In the operation flow, the next pattern drive unit operation is started before the reference lens position BP and the focus area position AP are renewed in steps S209 and S210 subsequent to the pattern drive unit operation to which attention is paid. Consequently, the reference lens position BP and the focus area position AP renewed in steps S209 and S210 are reflected in the pattern drive unit operation executed in the cycle after the next cycle.

By the operation flow, in the normal control state including steps S208 to S210, while reversing the driving direction DD of the focus lens unit 301 around the reference lens position BP which is continuously renewed, the pattern drive AF control is repeated. Even in the case where the subject is temporarily lost and the control state is changed to the extended control state, if focusing on the main subject can be achieved again before the predetermined time t′ elapses, the control state is changed again to the normal control state. While reversing the driving direction DD of the focus lens unit 301 around the reference lens position BP, the pattern drive AF control is repeated at least for the predetermined time t′.

By the above operations, as long as the pattern drive AF control is continued, the lens position P does not change rapidly.

General AF Control of Digital Camera 1A

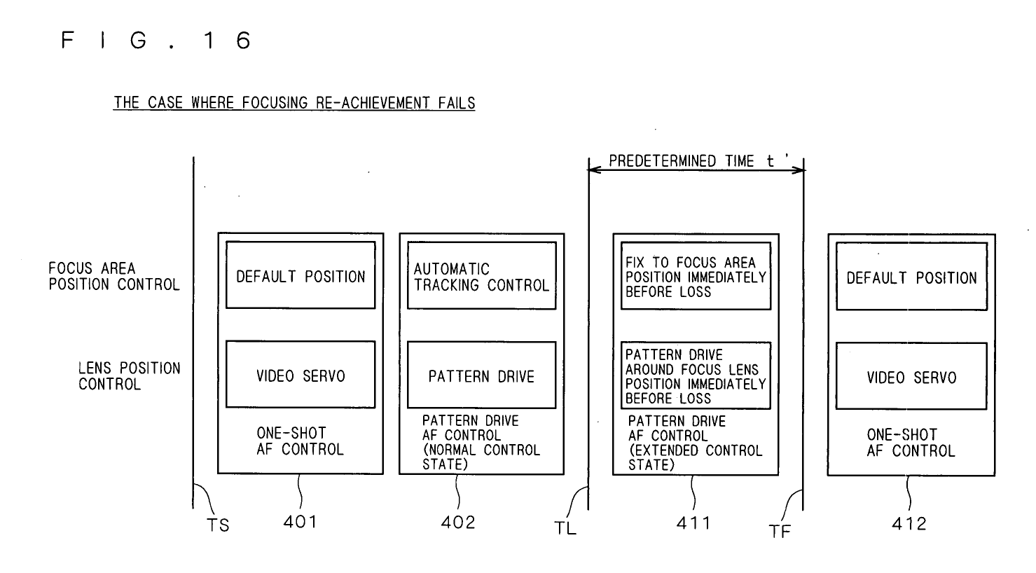

In the digital camera 1A, the one-shot AF control and the pattern drive AF control are used while being switched. As described above, the pattern drive AF control includes the normal control state and the extended control state. In the following, switching between the controls and change in the control state will be described with reference to the time charts of FIGS. 15 and 16.

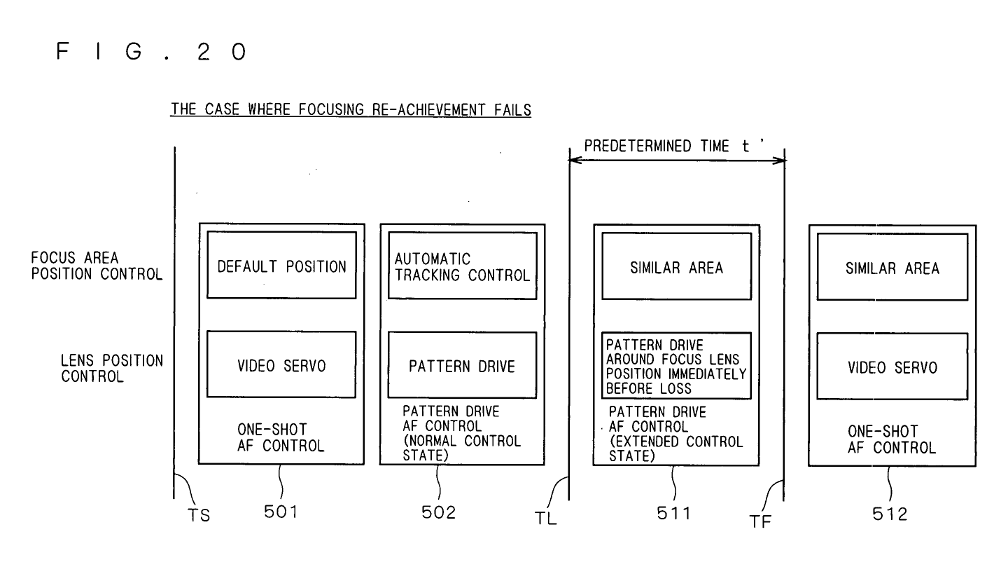

FIG. 15 is a time chart for describing the AF control performed in the case where focusing can be re-achieved on the main subject before the predetermined time t′ elapses since the loss of the subject occurs in the pattern drive AF control (since the extended control state is set) (hereinafter, this case will be referred to as “the case of success in re-achievement of focusing”). FIG. 16 is a time chart for describing the AF control performed in the case where focusing on the main subject cannot be achieved again before the predetermined time t′ elapses since the loss of a subject occurs in the pattern drive AF control (since the extended control state is set) (hereinafter, this case will be referred to as “the case of failure in re-achievement of focusing”). In each of the time charts of FIGS. 15 and 16, the lateral direction indicates time, and the direction from the left to the right corresponds to lapse of time. In the time charts of FIGS. 15 and 16, the concrete controls of the focus area position AP and the lens position P are written. In the time charts of FIGS. 15 and 16, AF control start time point TS at which the shutter start button 9 enters the S1 state, subject loss time point TL at which the lost time timer 219 is started, focusing re-achieved time point TR at which focusing on the main subject is re-achieved after the subject loss time point TL, and extended control end time point TF after lapse of the predetermined time t′ since the subject lost time point TL are also expressed by straight lines in the vertical direction (similarly expressed also in time charts of FIGS. 19 and 20 and FIGS. 22 and 23). In the following, the AF control of the digital camera 1A will be described with respect to the case where the focusing re-achievement succeeds and the case where the focusing re-achievement fails by referring to the time charts of FIGS. 15 and 16.

Case Where Focusing Re-Achievement Succeeds (FIG. 15)

The digital camera 1A starts the AF control from the AF control start time point TS at which the shutter start button 9 enters the S1 state. At the A F control start time point TS the infocus lens position FP is unknown. Consequently, first, the digital camera 1A executes one-shot AF control 401 to specify the infocus lens position FP. In the one-shot AF control 401, the focus area position AP is a default position. Although the default position is not limited, for example, the center of the display image ID can be preferably employed. When the focus lens unit 301 is driven to the infocus lens position FP by the video servo of the one-shot AF control, the infocus lens position FP is stored as the reference lens position BP into the RAM 151, and the one-shot AF control 401 is finished.

Subsequent to the end of the one-shot AF control 401, the digital camera 1A starts pattern drive AF control (normal control state) 402. In the pattern drive AF control 402, the focus area position AP changes so as to trace the movement of a main subject by automatic tracking control. By setting the initial position of the focus area position AP of the pattern drive AF control (normal control state) 402 to the same position as the default position of the one-shot AF control 401, the focus area position AP can be prevented from a rapid change at the time of shift from the one-shot AF control 401 to the pattern drive AF control (normal control state) 402 and it can prevent the user from feeling strange. In the pattern drive AF control (normal control state) 402, the focus lens unit 301 repeats reciprocation motion (pattern drive) around the reference lens position BP. When the reference lens position BP is renewed, the center point of the reciprocation motion changes little by little in association with the renewing. The reference lens position BP at the start time point of the pattern drive AF control (normal control state) 402 is the infocus lens position FP of the (normal control state) 402, so that the lens position P does not rapidly change at the time of shift from the one-shot AF control 401 to the pattern drive AF control (normal control state) 402. Thus, it can prevent the user from feeling strange. Since the center point of the reciprocation motion of the focus lens unit 301 which is executing the pattern drive AF control 402 is the reference lens position BP as the immediately preceding infocus lens position FP, as long as the loss of a subject does not occur, the lens position P does not change rapidly.

Next, the AF control of the digital camera 1A in the case where the loss of a subject occurs during execution of the pattern drive AF control (normal control state) 402, that is, the AF control after the subject loss time point TL will be described. In the case where the loss of a subject occurs during execution of the pattern drive AF control (normal control state) 402, the AF control of the digital camera 1A moves from the pattern drive AF control (normal control state) 402 to a pattern drive AF control (extended control state) 403. As described above, in the extended control state, renewing of the focus area position AP and the reference lens position BP is stopped. However, in the RAM 151, the focus area position AP and the reference lens position BP immediately before the renewing is stopped are stored. By using the focus area position AP and the reference lens position BP, the digital camera 1A continues the pattern drive AF control (extended control state) 403. In other words, the digital camera 1A fixes the focus area R to the focus area position AP immediately before the loss of the subject, and continues the reciprocation motion of the focus lens unit 301 around the infocus lens position FP immediately before the loss of the subject. Generally, when the loss of the subject temporarily occurs due to unexpected motion of the main subject, camera shake of the user of the digital camera, or invasion of a foreign matter into the focus area R, in many cases, the main subject does not move largely. Therefore, by executing such an AF control, even in the case where the loss of a subject occurs during execution of the pattern drive AF control (normal control state) 402, the possibility of re-achieving focusing on the main subject can be increased by a re-framing operation of a small amount by the user. By executing such an AF control, even in the case where the loss of a subject occurs during execution of the pattern drive AF control (normal control state) 402, it can prevent that the focus area position AP is rapidly reset to the default position or the lens position P rapidly changes due to the one-shot AF control. Thus, it can prevent the user from feeling strange. In addition, the possibility of re-achieving focusing on the main subject in short time can be increased.

Further, the AF control of the digital camera 1A in the case where focusing on the main subject is re-achieved during the extended control, that is, the AF control after the focus re-achieved time point TR will be described. In the case where focusing on the main subject is re-achieved, renewing of the focus area position AP and the reference lens position BP is re-started. Consequently, the digital camera 1A re-starts pattern drive AF control (normal control state) 404 similar to the pattern drive AF control (normal control state) 402 by using the focus area position AP and the reference lens position BP.

Case Where Focusing Re-Achievement Fail (FIG. 16)

The case where focusing re-achievement fails will now be described. Also in the case where re-achievement of focusing fails, the AF control up to the subject loss time point TL is similar to that in the case where re-achievement of focusing succeeds. In the case where re-achievement of focusing fails, even after lapse of the predetermined time t′ since the subject loss time point TL, focusing is not re-achieved. Therefore, pattern drive AF control (extended control state) 411 is interrupted, and one-shot AF control 412 similar to the one-shot AF control 401 is executed. The focus area position AP in this case is the default position. In such a manner, even in the case where the subject moves largely and focusing cannot be re-achieved by the framing of a small amount by the user, focusing can be re-achieved.

Second Preferred Embodiment

A digital camera 1B according to a second preferred embodiment of the present invention has a configuration similar to that of the digital camera 1A of the first preferred embodiment shown in FIGS. 1 to 4. However, a program stored in the ROM 152 of the digital camera 1B is different from the program stored in the ROM 152 of the digital camera 1A, so that the AF control of the AF controller 160 specified by the program stored in the ROM 152 of the digital camera 1A and that of the digital camera 1B are different from each other. In the following, the operation of the digital camera 1B will be described mainly with respect to the different points of operation from the digital camera 1A. The description of equivalent points other than the different points will not be repeated.

AF Control of Digital Camera 1B

Automatic Tracking Control

In the digital camera 1B, automatic tracking control different from that of the digital camera 1A is carried out. The automatic tracking control in the digital camera 1B will be concretely described below.

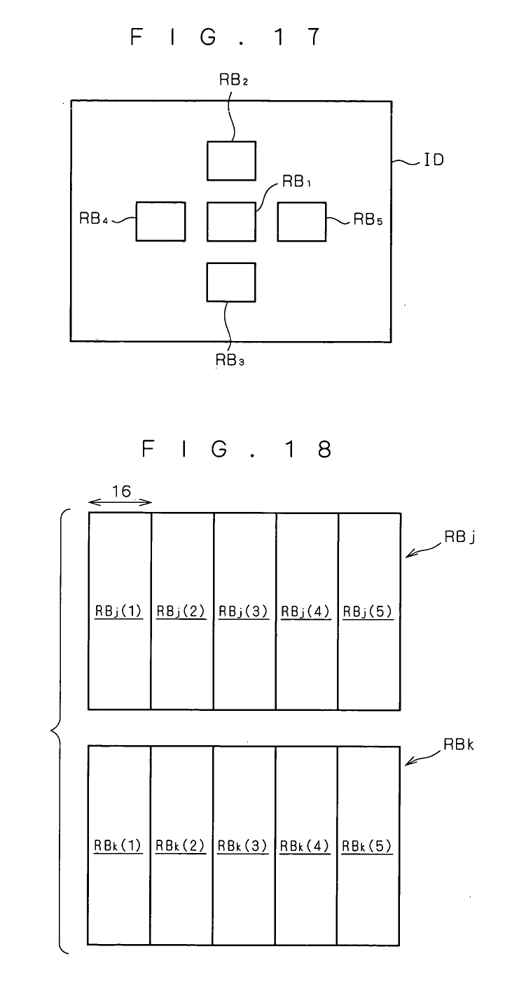

In the digital camera 1A, one focus area R of which position moves so as to trace movement of a main subject is provided in the display image ID. In the digital camera 1B, a plurality of local focus areas each having a fixed focus area position are provided in the display image ID. Although the number of local focus areas in the digital camera 1B is not limited, it is assumed here that five local focus areas RB₁ to RB₅ are provided. FIG. 17 shows an example of layout of the local focus areas RB₁ to RB₅ in the display image ID. In FIG. 17, the local focus area RB1 is set in the center of the display image ID. In upper, lower, left and right positions away from the local focus area RB1 each by a predetermined distance, the local focus areas RB₂ to RB₅ are set. In the digital camera 1B, one selected area SR selected from the local focus areas RB₁ to RB₅ is used for the AF control, as a focus evaluation area of which contrast value C is to be calculated. In the digital camera 1B, the selected area SR changes in response to the movement of the main subject, thereby performing the automatic tracking control.

A method of changing the selected area SR in response to movement of the main subject will now be described. It is assumed that a local focus area RB1 is the selected area SR in the n-th frame FLₙ. In this case, the AF controller 160 specifies, as the selected area SR, a local focus area having image information most similar to that of the local focus area RBᵢ among the local focus areas RB₁ to RB₅ in the (n+1)th frame FLₙ₊₁. To be specific, the AF controller 160 specifies, as a similar area, a local focus area having image information most similar to that of a local focus area used for the AF control in the immediately preceding frame and uses the specified similar area for the AF control. The image information as a criterion of similarity is not limited and may be color information, brightness information, or the like. In the following, a case of using a brightness value as the criterion of similarity will be described.

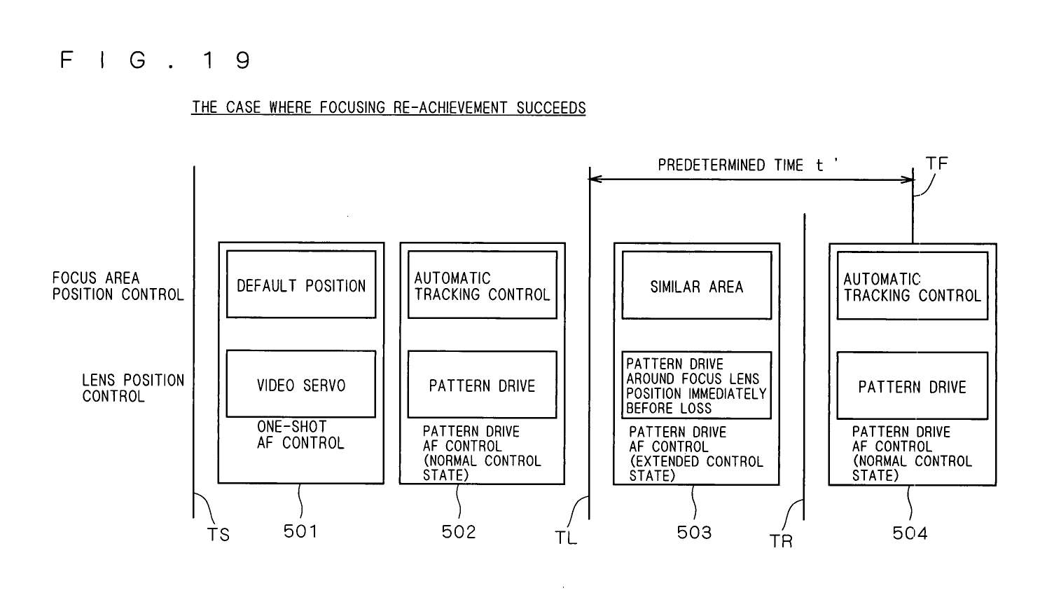

First, a method of evaluating similarity between two local focus areas RBⱼ and RBₖ will be described. The AF controller 160 divides each of the local focus areas RBⱼ and RBₖ into equal parts in the lateral direction in a manner similar to the focus areas RA1 or RA2 in the digital camera 1A shown in FIG. 9, thereby generating five divided areas RBⱼ(1) to RBⱼ(5) and RBₖ(1) to RBₖ(5) (FIG. 18). The AF controller 160 calculates brightness values BBⱼ(1) to BBⱼ(5) and BBₖ(1) to BBₖ(5) each as an average of each divided area. The AF controller 160 evaluates similarity between the local focus areas RBⱼ and RBₖ by using Equation 3. A parameter Sⱼₖ is a similarity parameter indicative of similarity between the local focus areas RBⱼ and RBₖ. The lower the parameter Sⱼₖ is, the higher the similarity is.

$${S}_{jk} = {\sum }_{m = 1}^{5} {\{ {BB}_{j} ( m ) - {BB}_{k} ( m ) \}}^{2} \qquad Equation 3$$

The AF controller 160 calculates similarity parameters Sᵢ₁ to Sᵢ₅ between the local focus areas RB1 in the frame FLₙ and the local focus areas RB₁ to RB₅ in the frame FLₙ₊₁. The AF controller 160 makes comparison among the similarity parameters Sᵢ₁ to Sᵢ₅ and determines the local focus area in the frame FLₙ₊₁, having the smallest similarity parameter as the selected area SR in the next (n+2)th frame FLₙ₊₂, thereby realizing tracking of the main subject in the digital camera 1B.

As described above, the automatic tracking control in the digital camera 1B is also performed on the basis of the image for AF obtained in two frames. Consequently, the part regarding the automatic tracking control in the time chart of FIG. 12 for describing the pattern drive AF control of the digital camera 1A is similar to that in the digital camera 1B.

Although the focus area R is divided into five parts in the lateral direction in the foregoing description, the present invention is not limited to the dividing method and the number of divided parts. For example, the focus area R may be divided into parts in a matrix. The number of divided parts may be four or less, or six or more. As a special case, the number of divided parts may be one.

General AF Control of Digital Camera 1B

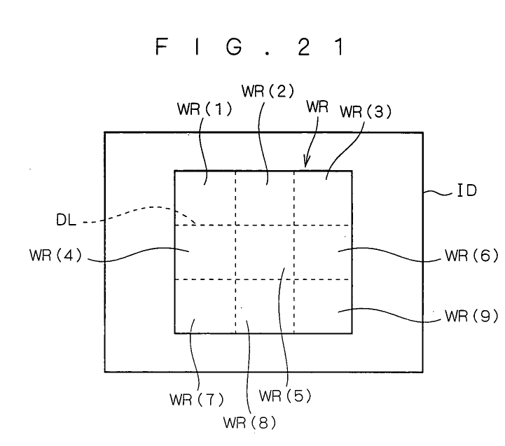

In the digital camera 1B, in a manner similar to the digital camera 1A, the one-shot AF control and the pattern drive AF control are used while being switched. In the following, switch between the controls and a change in the control state will be described below with reference to the time charts of FIGS. 19 and 20.

FIG. 19 is a time chart for describing the AF control performed in the case where focusing re-achievement succeeds. FIG. 20 is a time chart for describing the AF control performed in the case where focusing re-achievement fails. In the following the AF control of the digital camera 1B will be described with respect to the case where focusing re-achievement succeeds and the case where focusing re-achievement fails.

Case Where Focusing Re-Achievement Succeeds (FIG. 19)

The digital camera 1B starts pattern drive AF control (normal control state) 502 subsequent to one-shot AF control 501 up to the subject loss time point TL in a manner similar to the digital camera 1A. However, different from the digital camera 1A, the focus area position AP is determined by the above mentioned automatic tracking control peculiar to the digital camera 18.

The AF control of the digital camera 1B from the subject lost time point TL will now be described. From the subject lost time point TL, the digital camera 1B shifts from the pattern drive AF control (normal control state) 502 to pattern drive AF control (extended control state) 503 in a manner similar to the digital camera 1A. At this time, the AF controller 160 fixes the focus area position AP not in the focus area position AP just before the loss of a subject occurs but in a focus area position in the area similar to the selected area SR just before the loss of a subject occurs. The similarity is evaluated by using the similarity parameter S in the description of the automatic tracking control. By using the similar area as described above, the pattern drive AF control is executed in a focus area having high possibility that the main subject exists. Thus, the possibility that focusing re-achievement succeeds can be increased.

As the AF control of the digital camera 1B in the case where focusing on a main subject is re-achieved during execution of the pattern drive AF control (extended control state) 503 that is, the AF control from the focusing re-achievement time point TR, in a manner similar to the digital camera 1A, pattern drive AF control (normal control state) 504 similar to the pattern drive AF control (normal control state) 502 is re-started.

Case Where Focusing Re-Achievement Fails (FIG. 20)

The case where focusing re-achievement fails will now be described. Also in the case where re-achievement of focusing fails, the AF control up to the subject loss time point TL is similar to that in the case where re-achievement of focusing succeeds. In the case where re-achievement of focusing fails, however, even after lapse of the predetermined time t′ since the subject loss time point TL, focusing is not re-achieved. Therefore, pattern drive AF control (extended control state) 511 is interrupted at an extended control end time point TF, and one-shot AF control 512 is executed again. The focus area position AP in this case is a focus area position in an area similar to the focus area immediately before the loss of a subject occurs. Consequently, the AF control is executed in the focus area in which the possibility that the main subject exists is high, so that the possibility of re-achieving focusing in short time can be increased.

Third Preferred Embodiment

A digital camera 1C according to a third preferred embodiment of the present invention has a configuration similar to that of the digital camera 1A of the first preferred embodiment shown in FIGS. 1 to 4. However, a program stored in the ROM 152 of the digital camera 1C is different from the program stored in the ROM 152 of the digital camera 1A, so that the AF control of the AF controller 160 specified by the program stored in the ROM 152 of the digital camera 1A and that of the digital camera 1C are different from each other. In the following, the operation of the digital camera 1C will be described mainly with respect to the different points of operation from the digital camera 1A. The description of equivalent points other than the different points will not be repeated.

AF Control of Digital Camera 1C

Wide Focus Area

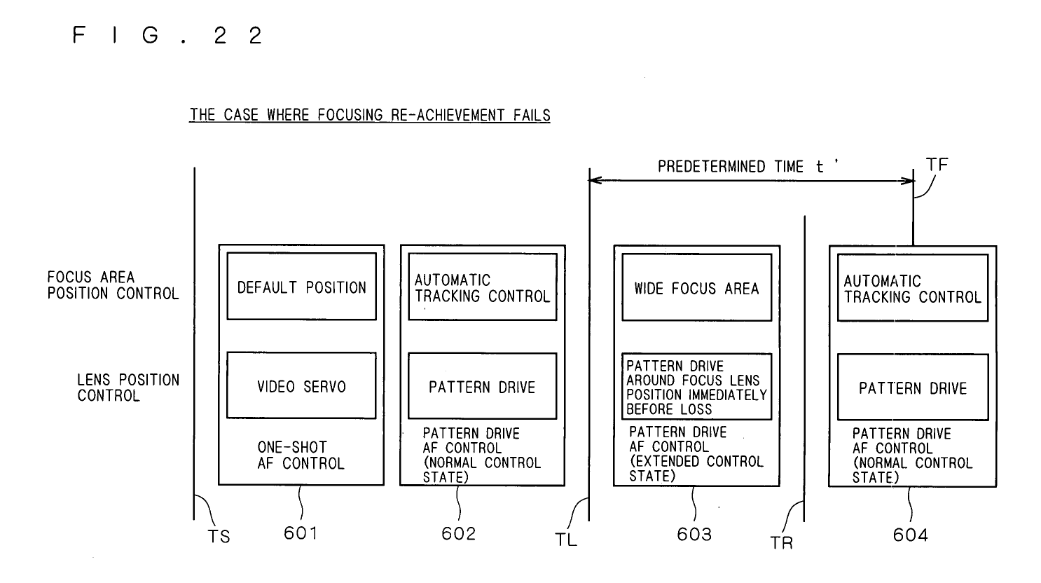

In the digital camera 1C, in addition to the focus area R similar to that in the digital camera 1A, a wide focus area WR wider than the focus area R is set in the display image ID. FIG. 21 shows an example of layout of the wide focus area WR.

The length in each of the vertical and horizontal directions of the wide focus area WR is three times as long as that of the focus area R. The position of the wide focus area WR is set in the center of the display image ID. In the wide focus area WR, total nine sub-focus areas WR(1) to WR(9) in three rows and three columns are set. Broken lines DL in FIG. 21 are shown for convenience in order to clarity the sub-focus areas WR(1) to WR(9) and are not included in an actual display image ID.

The AF controller 160 can calculate the contrast value C and the brightness value B of each of the sub-focus areas WR(1) to WR(9) and the wide focus area WR. The wide focus area WR and the sub-focus areas WR(1) to WR(9) are used in the extended control state of the pattern drive AF control. The shape WR of each of the sub-focus areas WR(1) to WR(9) is the same as that of the focus area R in the digital camera 1A.

General AF Control of Digital Camera 1C

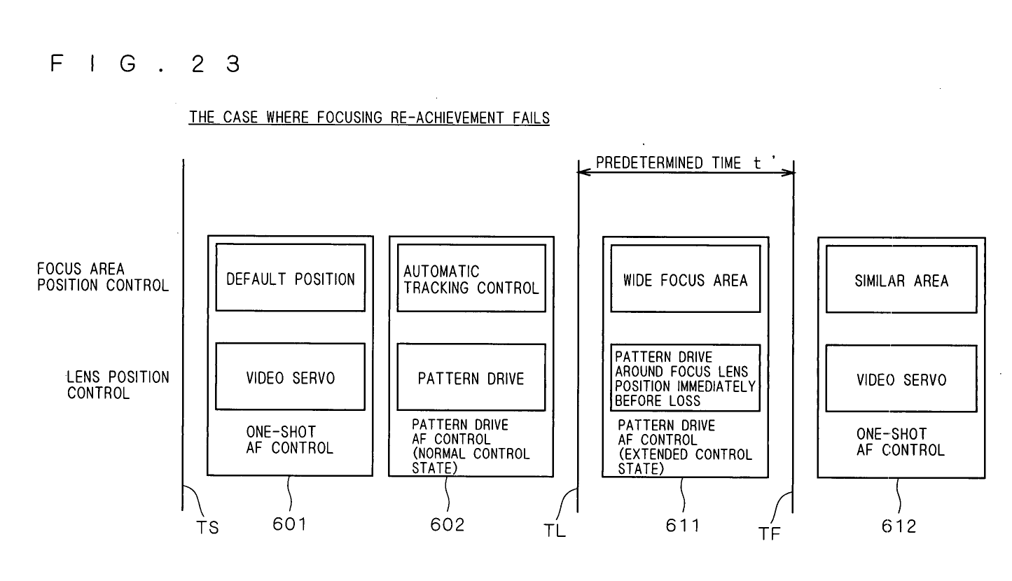

In the digital camera 1C, in a manner similar to the digital camera 1A, the one-shot AF control and the pattern drive AF control are used while being switched. In the following, switching between the controls and change in the control state will be described with reference to the time charts of FIGS. 22 and 23.

FIG. 22 is a time chart for describing the AF control performed in the case where focusing re-achievement succeeds. FIG. 23 is a time chart for describing the AF control performed in the case where focusing re-achievement fails. In the following, the AF control of the digital camera 1C will be described with respect to the case where the focusing re-achievement succeeds and the case where the focusing re-achievement fails.

Case Where Focusing Re-Achievement Succeeds (FIG. 22)

The digital camera 1C performs one-shot AF control 601 and, subsequently, pattern drive AF control (normal control state) 602 in a manner similar to the digital camera 1A up to the subject loss time point TL.

The AF control of the digital camera 1C after the subject loss time point TL will now be described. At the subject loss time point TL, the AF control of the digital camera 1C shifts, in a manner similar to the digital camera 1A, from the pattern drive AF control (normal control state) 602 to pattern drive AF control (extended control state) 603. At this time, the AF controller 160 changes the focus area not to the focus area R immediately before the loss of a subject but to the wide focus area WR. Since the area of the focus area increases, the possibility that a main subject is included in the focus area increases, and the possibility that focusing is re-achieved in short time increases.

Further, in the case where focusing on the main subject is re-achieved during execution of the pattern drive AF control (extended control state) 603, that is, after the focus re-achievement time point TR, the AF controller 160 of the digital camera 1C re-starts pattern drive AF control (normal control state) 604 in a manner similar to the digital camera 1A. At this time, the initial position of the focus area R is the position of a focus area most similar to the focus area immediately before the loss of the subject among the sub-focus areas WR(1) to WR(9).

Case Where Focusing Re-Achievement Fails (FIG. 23)

The case where focusing re-achievement fails will now be described. Also in the case where re-achievement of focusing fails, the AF control up to the subject loss time point TL is similar to that in the case where re-achievement of focusing succeeds. In the case where re-achievement of focusing fails, however, even after lapse of the predetermined time t′ since the subject loss time point TL, focusing on the main subject is not re-achieved. Therefore, pattern drive AF control (extended control state) 611 is interrupted at the extended control end time point TF, and one-shot AF control 612 is executed. The focus area R in this case is a focus area most similar to the focus area immediately before the loss of a subject among the sub-focus areas WR(1) to WR(9). Consequently, the AF control is performed in the focus area in which the possibility that the main subject exists is high, so that the probability of re-achieving focusing in short time can be further increased.

Modifications

Although the immediately-preceding infocus lens position FP is used as the reference lens position BP in the digital cameras 1A to 1C of the first to third preferred embodiments, the method of determining the reference lens position BP is not limited to this method. For example, it is also possible to store immediately-preceding two infocus lens positions FP1 and FP2 in the RAM 151 and use the lens position P calculated on the basis of the two infocus lens positions FP1 and FP2 as the infocus lens position FP. Although a calculating method is not particularly limited, for example, a calculating method shown by Equations 4 and 5 can be employed.
FP═FP2+ΔFP Equation 4
ΔFP═FP2−FP1 Equation 5

FP2 and FP1 denote the last infocus lens position and the infocus lens position before the last infocus lens position, respectively. ΔFP denotes an amount of a change in the lens position P immediately before the loss of a subject. Consequently, the calculating method shown by Equations 4 and 5 is a calculating method in which not only the infocus lens position FP immediately before the loss of a subject but also movement of the focus lens unit 301 are considered. More concretely, the calculating method is a method of calculating the infocus lens position FP at the present time point on assumption that a change in the focus lens positions P at two time points immediately before the loss of a subject continues similarly (moving object forecast). By the method, even if the motion of the subject becomes large to an extent in the normal control state of the pattern drive AF control, it becomes possible to continuously maintain focusing. Also in the extended control state, the possibility of re-achieving focusing in short time can be further increased.

In the digital cameras 1A to 1C of the first to third preferred embodiments, the AF control is started in response to light-press of the shutter start button 9. Alternately, the AF control may be started at turn-on.

While the invention has been shown and described in detail, the foregoing description is in all aspects illustrative and not restrictive. It is therefore understood that numerous modifications and variations can be devised without departing from the scope of the invention.

1. An image capturing apparatus for capturing image data on the basis of a light image acquired by an optical system, comprising:
a focusing member for achieving focus by moving said optical system to an infocus position; and
a controller for moving a position of a focus area which is set in an image formed by the light image so that the focus area includes a main subject, determining a present focus position from a plurality of pieces of information in the focus area, obtained by driving said optical system around a reference position determined on the basis of a prior infocus position, and moving said optical system to the present infocus position by controlling said focusing member, wherein
at the time of losing track of the main subject during its control, said controller continues to drive said optical system around a reference position determined on the basis of the latest infocus position.

2. The image capturing apparatus according to claim 1, wherein
at the time of losing track of the main subject during its control, said controller continuously uses a focus area in which the latest infocus position is obtained.

3. The image capturing apparatus according to claim 1, wherein
at the time of losing track of the main subject during its control, said controller specifies an area of which image information is similar to image information of the focus area in which the latest infocus position is obtained, and uses the focus area specified.

4. The image capturing apparatus according to claim 1, wherein
when the main subject cannot be found after continuing to drive said optical system for predetermined time around the reference position determined on the basis of the latest infocus position, said controller determines a present infocus position irrespective of the reference position determined on the basis of the latest infocus position.

5. The image capturing apparatus according to claim 4, wherein
at the time of determining a present infocus position irrespective of the reference position determined on the basis of the latest infocus position, said controller uses a focus area in a predetermined default position.

6. The image capturing apparatus according to claim 1, wherein
the reference position determined on the basis of the latest infocus position when the track of the main subject is lost during control of said controller is the latest infocus position itself.

7. The image capturing apparatus according to claim 1, wherein
the reference position determined on the basis of the latest infocus position when the track of the main subject is lost during control of said controller is determined on the basis of infocus positions at a plurality of time points in the past.

8. The image capturing apparatus according to claim 1, wherein
the plurality of pieces of information in the focus area obtained by driving said optical system around the reference position is information obtained on both sides of the reference position.

9. The image capturing apparatus according to claim 4, wherein
at the time of losing the track of the main subject during its control, said controller specifies an area of which image information is similar to image information of the focus area in which the latest focus position is obtained, and
when the main subject cannot be found after continuing to drive said optical system for predetermined time around the reference position determined on the basis of the latest infocus position, said controller determines the present infocus position in the area specified irrespective of the reference position determined on the basis of the latest infocus position.

10. The image capturing apparatus according to claim 1, wherein
when the track of the main subject is lost during control of said controller, a wide focus area is used.

11. The image capturing apparatus according to claim 10, wherein
at the time of losing the track of the main subject during its control, said controller specifies an area of which image information is similar to image information of the focus area in which the latest infocus position is obtained, and
when the main subject cannot be found after continuing the driving of said optical system for predetermined time around the reference position determined on the basis of the latest infocus position, said controller determines the present infocus position in the area specified irrespective of the reference position determined on the basis of the latest infocus position.

12. The image capturing apparatus according to claim 11, wherein
the wide focus area is divided into a plurality of equal partial areas, and an area having similar image information is selected from the partial areas.

13. The image capturing apparatus according to claim 3, wherein
the image information is brightness information or color information.

14. The image capturing apparatus according to claim 1, wherein
a plurality of local focus areas in different positions are set in an image, and the focus area is selected from the local focus areas.

15. The image capturing apparatus according to claim 14, wherein
at the time of losing the track of the main subject during its control, said controller selects an area of which image information is similar to image information of the focus area in which the latest infocus position is obtained from the local focus areas, and uses the selected area.

16. An image capturing apparatus comprising:
an optical system for capturing a light image including a subject;
a driver for driving a focus lens of said optical system;
an image sensor for converting the light image into image data;
a renewing part for renewing the position of a focus area set in an image in which the image data is obtained on the basis of movement of the subject;
a controller for controlling said driver on the basis of image information in the focus area to move the focus lens to an infocus lens position in which a focusing state can be achieved; and
a selector capable of switching a control mode of said controller between (1) a first control mode of specifying a present infocus lens position from the image information obtained by driving the focus lens around a reference lens position determined on the basis of a prior infocus lens position, and (2) a second control mode of specifying a present infocus lens position independently of the prior infocus lens position, wherein
when the present infocus lens position becomes unspecified during control in the first control mode, control in the first control mode is continued.

17. The image capturing apparatus according to claim 16, wherein
the position of the focus area during a continuous control is fixed to a position renewed immediately before a time point when the infocus lens position became unspecified.

18. The image capturing apparatus according to claim 16, wherein
a similar area of which image information is similar to the image information in the focus area in the position renewed immediately before a time point when the infocus lens position became unspecified can be specified, and
the position of the focus area during a continuous control is fixed to a position of a similar area.

19. The image capturing apparatus according to claim 16, wherein
when the infocus lens position cannot be specified after performing a continuous control for a predetermined time, the control mode is switched to the second control mode.

20. The image capturing apparatus according to claim 19, wherein
the position of the focus area in the second control mode is a predetermined default position.
